(19) United States
(12) Patent Application Publication
(10) Pub. No.: US 2010/0030624 A1
(43) Pub. Date: Feb. 4, 2010

(54) METHOD AND APPARATUS FOR MAKING DAILY SHOPPING EASIER

(75) Inventors: Marko Vänskä, Espoo (FI); Sami Ranta, Helsinki (FI); Raimo Malila, Helsinki (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/533,719

(22) Filed: Jul. 31, 2009

Related U.S. Application Data
(63) Continuation of application No. 10/291,038, filed on Nov. 8, 2002, now abandoned.

(51) Int. Cl. G06Q 30/00; G06F 17/00; G01C 21/00; G06Q 10/00; G06F 15/16; H04B 7/00

(52) U.S. Cl. 705/10; 235/375; 701/300; 705/26; 709/204; 455/41.2

(57) ABSTRACT

An apparatus and method for facilitating a shopping experience. A user creates and stores a shopping list in a mobile terminal. Upon entering a shop, the mobile terminal downloads a shopping mini-application, which checks item availability and provides recommended substitute and complimentary items preferably taking user profile information into consideration. The mobile terminal also provides the user with reminders based on the user's purchasing history. Special offers are also presented to the user. Once the shopping list has been finalized, an optimal shopping route is computed for gathering the items on the list and is displayed to the user in the form of a map. The optimal route and recommendations may be updated at any time throughout the shopping experience in response to either the user's request, modifications to the shopping list and/or the user's divergence from the optimal route. The mini-application automatically may be deleted at the POS to conserve memory space.

### FIELD OF THE INVENTION

The present invention relates to wireless communications systems in general and, more particularly, to an apparatus and method for facilitating a consumer's shopping experience at a service provider's premises.

### BACKGROUND OF THE INVENTION

In today's busy world, people want to be able to conduct their daily shopping, such as their grocery shopping, quickly and easily. The shops similarly want to provide consumers with a pleasant shopping experience, which includes increasing the speed at which consumers can complete their shopping and return to other more important aspects of their lives. The main challenge to these goals involves the shops being able to match the services/goods being offering to those items on a consumer's shopping list.

Quite often, however, items sought by a consumer are out of stock at the store. This results in a consumer having to spend time looking for a substitute item, which, if selected by the consumer in haste, may turn out to be either not a true substitute or an item that is otherwise unsuitable for the consumer. Moreover, if the consumer does not have the time to search for a substitute, she may forego making a purchase altogether, much to the shop owner's dismay and her own frustration.

Consumers also frequently forget to place items that they need on their shopping lists. For example, consumers may forget to list items that they are running low on or items that they ordinarily do not purchase but which they may be need in special instances such as when trying a new recipe. This often results in the consumer realizing her oversight upon returning home and either having to make a disappointing change to the evening's menu or making another trip to the store that same day. Conversely, consumers often buy an item forgetting that they already have plenty of it at home, which results in potential waste if the item purchased earlier cannot be consumed before its expiration date.

What is needed is a mechanism to facilitate a consumer's shopping experience to overcome these and other shopping-related problems.

### SUMMARY OF THE INVENTION

The above-identified problems are solved and a technical advance is achieved in the art by an apparatus and method for providing a user of a mobile terminal with shopping advice.

An exemplary method for providing a user of a mobile terminal with shopping advice includes: accessing a user's electronic shopping list; identifying a substitute item for an item on the shopping list; notifying the user of the substitute item via the mobile terminal; and providing the user with a route for purchasing items on the shopping list, wherein the route includes a location of the substitute item.

In an alternate embodiment, an exemplary method includes: accessing a user's electronic shopping list; identifying a complimentary item for an item on the shopping list; notifying the user via the mobile terminal of the complimentary item; and providing the user with a route for purchasing items on the shopping list, wherein the route includes a location of the complimentary item.

In an embodiment directed to a method for providing a user of a mobile terminal with a reminder concerning an item for purchase, an exemplary method includes: determining the user's purchasing history for an item, the purchasing history including a purchasing frequency and a date of last purchase; based on the user's purchasing history, providing a reminder concerning the item to the user via the mobile terminal; and providing the user with a route for shopping for items on an electronic shopping list, wherein the route may include a location of the item for which a reminder was provided.

Other and further aspects of the present invention will become apparent during the course of the following description and by reference to the attached drawings.

### BRIEF DESCRIPTION OF THE DRAWINGS

FIG. 1 is a block diagram illustrating an exemplary arrangement between a mobile terminal and a service provider for facilitating a shopping experience in accordance with one embodiment of the present invention.

FIG. 2 is a block diagram illustrating an exemplary mobile terminal in accordance with one embodiment of the present invention.

FIG. 3 is a flowchart illustrating an exemplary process by which a consumer's shopping experience is facilitated in accordance with one embodiment of the present invention.

FIG. 4 is a diagram of an exemplary shopping list of a consumer.

FIG. 5 is a diagram of an exemplary data file provided by a service provider in accordance with one embodiment of the present invention.

FIG. 6 is a diagram of an exemplary consumer profile.

FIG. 7 is a diagram of an exemplary past purchasing history of a consumer.

FIG. 8A is a block diagram illustrating an optimal shopping route displayed to a consumer in accordance with one embodiment of the present invention.

FIG. 8B is a block diagram illustrating an updated optimal shopping route in accordance with an alternate embodiment of the present invention.

### DETAILED DESCRIPTION

In the following description of the various embodiments, reference is made to the accompanying drawings which form a part hereof, and in which are shown by way of illustration various embodiments in which the invention may be practiced. It is to be understood that other embodiments may be utilized and structural and functional modifications may be made without departing from the scope of the present invention.

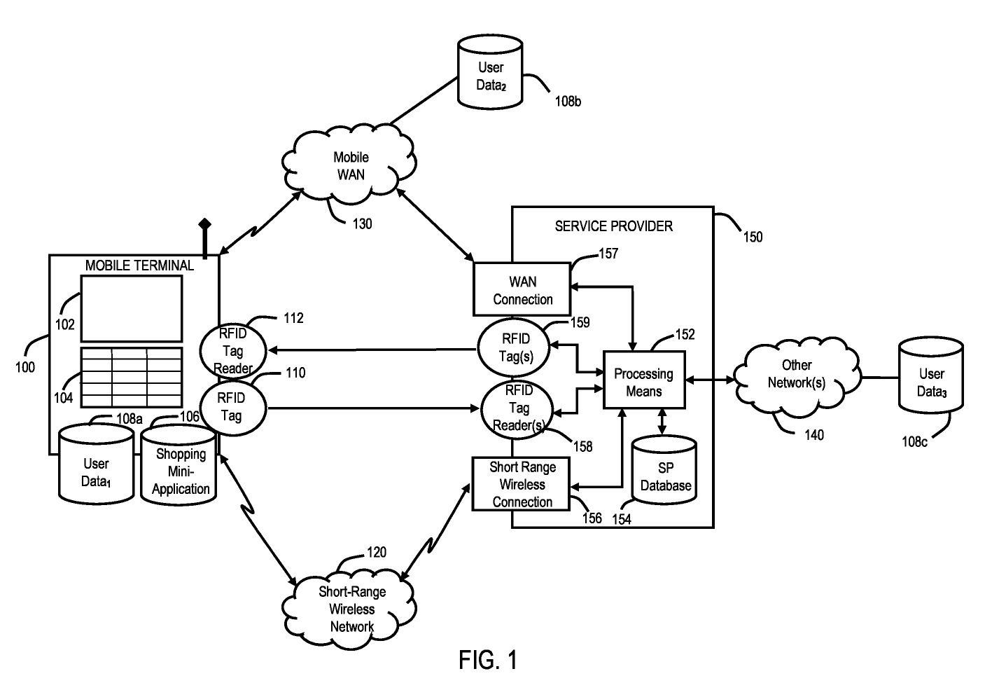

Referring now to the drawings, wherein like reference numerals refer to like parts, FIG. 1 is a block diagram illustrating an exemplary arrangement between a mobile terminal 100 and a service provider 150 for facilitating a shopping experience in accordance with one embodiment of the present invention.

As shown in FIG. 1, service provider 150, which may be a single entity, such as a single store, or an entity representing a plurality of stores, such as a shopping mall, includes a processor 152 coupled to a data base 154 for storing a shopping mini-application together with associated data including item availability, locations of the items within a predetermined area such as a shopping mall, a shop or smaller locations therein such as departments, aisles, shelves, etc. (hereinafter referred to as, but not intended to be limited to, a service provider 150's shop) and map data associated with the shop, in one embodiment, for downloading to a consumer's mobile terminal 100.

A mini-application is an executable software item, such as a Java applet, a script or a software agent of limited operability for performing one or more functions on a mobile terminal 100. With respect to its limited operability, in addition to being associated with one or more conditions for its deletion, a mini-application is preferably also associated with one or more conditions for one or more of its downloading, activation and deactivation. A “condition” may be, but is not intended to be limited to, the physical location of the mobile terminal 100. Mini-applications are discussed in detail in co-pending U.S. patent application Ser. No. ______, entitled “Disposable Mini-applications” filed in the name of Marko Vanska et al. on Nov. 1, 2002, a copy of which is incorporated herein by reference.

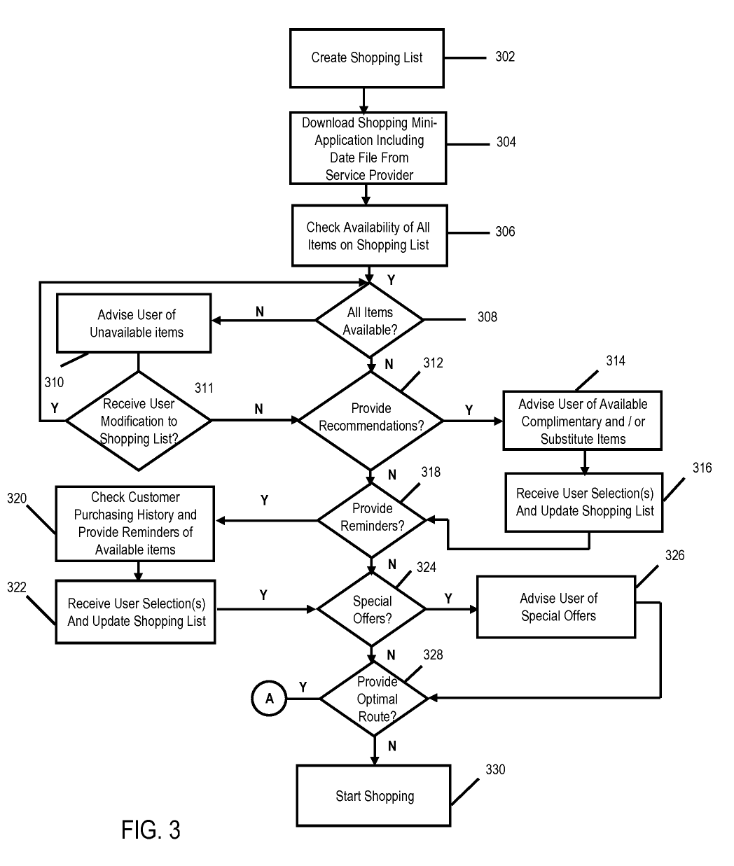

As will be discussed in detail hereinafter in connection with FIG. 3, when downloaded to a consumer's mobile terminal 100, a mini-application together with associated data guides the consumer through a shopping experience by providing her with, among other things: recommended substitutes for items on her shopping list; recommended items that compliment those on the shopping list; reminders to buy items that are not on the shopping list but which she currently may need based on her purchasing history; and an optimal route through a shop to obtain the items on the shopping list including any recommended substitute or complimentary items as well as any items about which the user received a reminder.

Service provider 150 includes various mechanisms for exchanging information with mobile consumers including connection 156 for communicating via short range wireless network 120, such as a Personal Area Network (e.g., IrDA or Bluetooth PANs) or a wireless LAN (e.g., wireless IEEE 1394, IEEE 802.11 or HiperLAN/2) and connection 157 for communicating via mobile WAN (e.g. GPRS, GSM, etc.) 130. In various embodiments, these connections are used for downloading the shopping mini-application and any associated data that will be used by the application to mobile terminal 100, as will be discussed in detail hereinafter. Service provider 150 also includes RF-ID tag readers 158 and RF-ID tags 159, which may also be used for downloading a shopping mini-application and any associated data to mobile terminal 100, as well as for determining a user's location within a shop for use in calculating an optimal shopping route, as will be discussed in detail hereinafter.

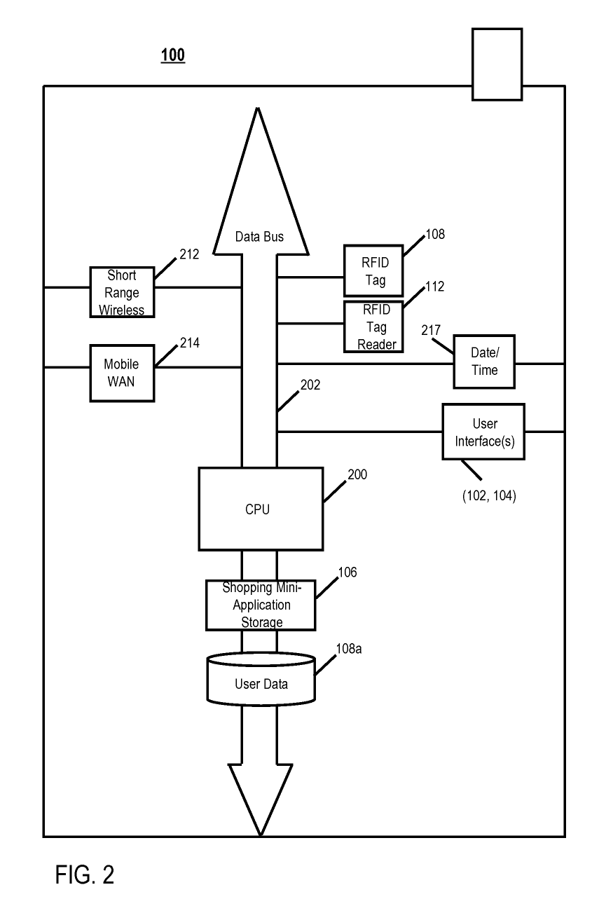

Mobile terminal 100, which may be a hand-held wireless telephone, a personal digital assistant (“PDA”), a lap-top computer or the like includes user interfaces 102, 104, shopping mini-application storage 106, user data storage 108a, an RF-ID tag 110 and an RF-ID tag reader 112, as well as additional components, all of which will be discussed in detail hereinafter in connection with FIG. 2.

The RFID tag reader 112 of mobile terminal 100 in connection with the RF-ID tags 159 of service provider 150 constitute an RF-ID system, which may be used in one embodiment to download a shopping mini-application and determine a user's location within a shop for purposes of providing the user with an optimal shopping route, as will be discussed in detail hereinafter. Similarly, the RF-ID tag 110 of mobile terminal 100 in connection with RF-ID tag readers 158 of service provider 150 constitute an alternate RF-ID system for determining a user's location, as will also be discussed in detail hereinafter.

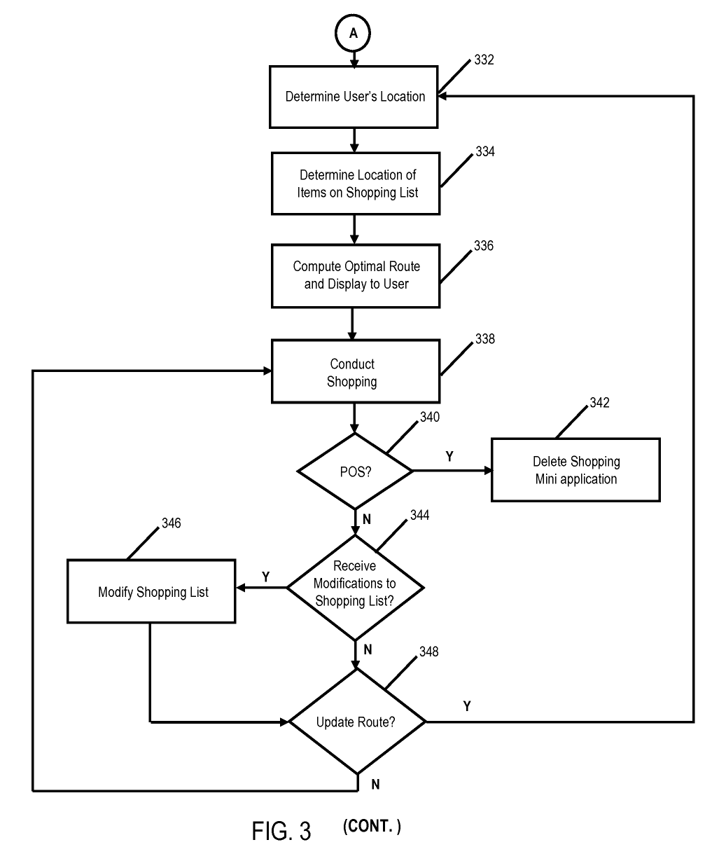

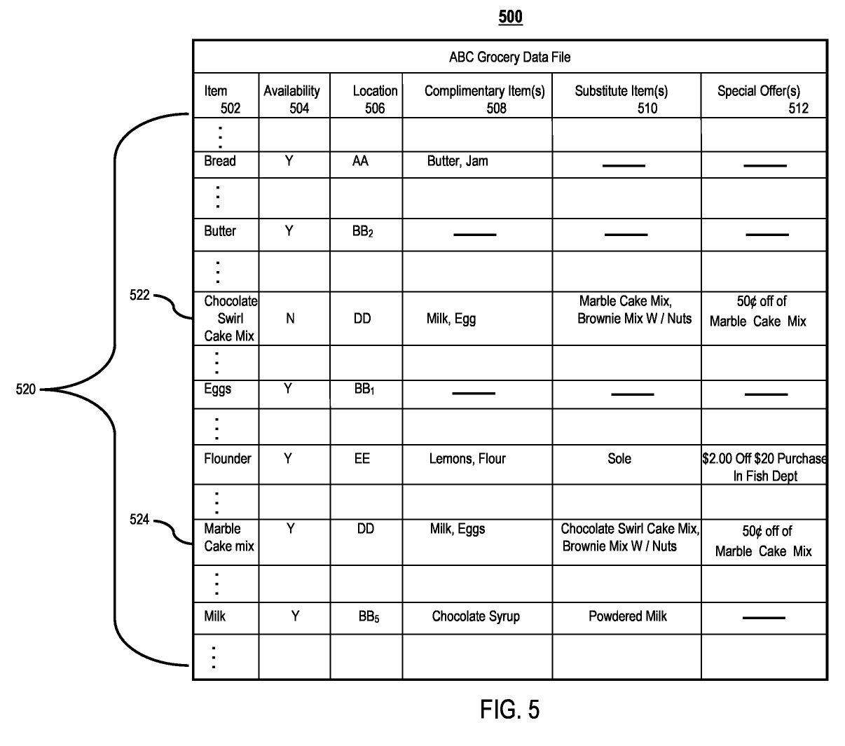

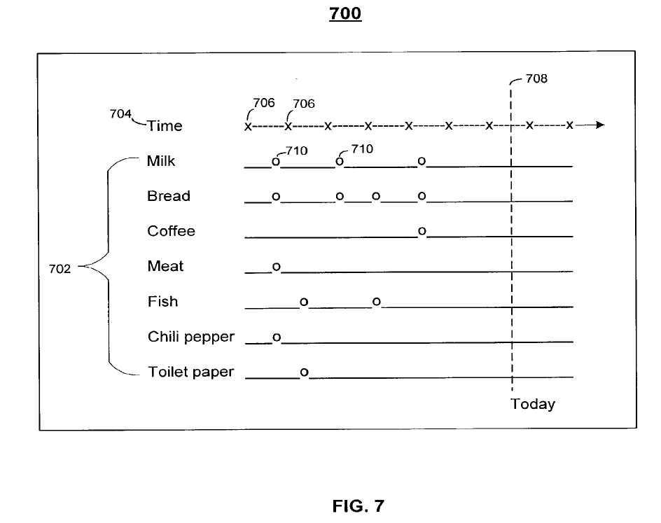

Data storage 108a of mobile terminal 100 may contain a variety of shopping-related user data for use by the shopping mini-application to facilitate the user's shopping experience. For example, it may contain a user's shopping list, which identifies items that the user intends to purchase from, e.g., service provider 150, as will be discussed in detail hereinafter in connection with FIG. 4. Storage 108a also may contain a user profile, which may include the user's preferences vis-à-vis usage of the shopping mini-application as well as the user's consuming preferences, as will be discussed in detail hereinafter in connection with FIG. 6. The profile may be created by the user of mobile terminal 100. Alternatively, it may by created by service provider 150 either from user data stored locally in data base 154, such as a user's past purchasing history with this particular service provider, or from other shopping-related user data 108c that is remotely accessible by service provider 150 via network(s) 140. Lastly, storage 108a may contain the user's purchasing history including the date of her latest purchase of one or more items and her buying frequency of the items, as will be discussed in detail hereinafter in connection with FIG. 7. Alternatively, or in addition thereto, a user of mobile terminal 100 may store one or more of these types of user data remotely in a network, rather than locally in terminal 100, as illustrated by the reference to user data 108b in FIG. 1.

FIG. 2 is a block diagram illustrating an exemplary mobile terminal in accordance with one embodiment of the present invention. As shown in FIG. 2, mobile terminal 100 includes user interfaces 102, 104. Interface 102 is a display, preferably one with a touch screen capability, as is well-known in the art. The display 102 preferably is also capable of presenting textual, graphical and/or image data in the form of a map of a service provider 150's shop to the user. Interface 104 is a keypad, which preferably comprises numerous function keys such as alpha-numeric keys and directional (arrow) keys, for permitting a user to perform such functions described herein as creating and modifying shopping lists as well as scrolling across and or zooming in or out of a map on the display 102. Alternatively, or in addition thereto, a pointing device may be used for manipulating stored and/or displayed data.

Terminal 100 also includes a CPU 200 and associated programming for controlling data processing and transfer operations among the various elements of terminal 100 via a data transfer bus 202. As shown in FIG. 2, terminal 100 further includes user data storage 108a for storing a user's shopping list, a user's profile and the user's purchasing history for use by the downloaded shopping mini-application 106 in facilitating the user's shopping experience, as will be discussed in detail hereinafter in connection with FIG. 3. Terminal 100 also includes a date/time means for determining a current date and time for use in logging purchases to maintain the user's purchasing history in user data base 108a.

As further shown in FIG. 2, mobile terminal 100 also includes connections 212 and 214 for communicating with a service provider 150 via short range wireless network 120 and mobile WAN 130, respectively. In various embodiments, either of these connections may be used to communicate with service provider 150 for purposes of downloading a shopping mini-application and associated data.

Mobile terminal 100 also includes RFID tag 108 and RF-ID tag reader 112. An RF-ID wireless system comprising RF-ID tags and RF-ID readers may be used in one embodiment of the present invention to determine the user's proximity to, or location within, a service provider 150's shop for use in downloading, activating, deactivating or deleting a shopping mini-application and associated data, as well as for use in calculating an optimal shopping route while the mobile terminal 100 is located within the shop.

An RF-ID tag is a wireless transponder that may contain varying amounts of information ranging from a tag identifier to 128 Kbytes of variable memory that can be programmed with additional information. An RF-ID reader communicates with a tag through the use of RF energy. In particular, an RF reader sends out an interrogation signal which “wakes up” a tag situated within a predetermined proximity to the reader. A tag may be “passive” in that it operates without an internal battery source, deriving the power to operate from the RF field generated by the RF-ID reader, which is inductively coupled to the tag. Alternatively, a tag may be “active”, and thus, powered by an internal battery that allows a greater communication range and higher data transmission rates. Once interrogated, the tag will transmit a signal including its ID number and possibly other information back to the RF-ID reader. RF-ID wireless network principles are described in a publication entitled “Radio Frequency Identification: A Basic Primer”, published by Automatic Identification Manufacturers (AIM), website: (www.aimglobal.org), Aug. 23, 2001, a copy of which is incorporated herein by reference.

In one embodiment of the present invention, RF-ID tag 110 of mobile terminal 100 may be used by service provider 150 to detect the user's entry into its shop so that a shopping mini-application may be downloaded to terminal 100 either from an RF-ID tag 159 of service provider 150 to an RF-ID reader 112 of mobile terminal 100 or via a bi-directional network such as a short range wireless network 120. The RF-ID tag 110 also may be used to provide the service provider 150 with the terminal 100's current location within, and departure from, the shop. The service provider 150 can then transmit this location information to terminal 100 via network 120 for use by the mini-application in updating an optimal shopping route or, upon reaching the POS or exiting the shop, deleting the mini-application from memory, as will be discussed in detail hereinafter in connection with FIG. 3. Alternatively, mobile terminal 100 may use its RF-ID tag reader 112 to determine its current location within, and departure from, the shop by sensing one or more of service provider 150's RFID tags 159 and provide this location information to the mini-application for the above-stated uses without the mobile terminal 100 having to disclose its location to service provider 150, as also will be discussed in detail hereinafter in connection with FIG. 3.

It will be readily appreciated that mobile terminal 100 also includes conventional hardware and functionality, which maybe employed in operating mobile terminal 100 as a mobile phone, but which are well known to those skilled in the art, and thus, are not shown in FIG. 2.

FIG. 3 is a flowchart illustrating an exemplary process by which a consumer's shopping experience is facilitated in accordance with one embodiment of the present invention. In step 302, a user of a mobile terminal 100 creates an electronic shopping list in advance of entering service provider 150's shop and stores the list in user data 108a of mobile terminal 100. The user may create the shopping list from a catalog or other advertisement provided by a service provider 150 whose shop she intends to visit.

An exemplary shopping list 400 is illustrated in FIG. 4. As shown in FIG. 4, the list 400 comprises one or more items 402 that the user of mobile terminal 100 intends to purchase. An item may be either a good or a service. Although not shown in FIG. 4, it will be appreciated that other information may be included in shopping list 400. This additional information may include the quantity of each item to be purchased and a more detailed item description, rather than simply a generic descriptor, including species descriptors (e.g., “ham” rather than, or in addition to, “meat”) and brand names (e.g., “Nokia” handsets) or other quality indicators (e.g., “Grade A” or “1^{st} Choice”).

Returning to FIG. 3, in step 304, mobile terminal 100 enters a service provider 150's shop. In one embodiment, mobile terminal 100's proximity to, or presence within, the shop is sensed by either terminal 100 or service provider 150 using RF-ID tags/readers. For example, one of service provider 150's RF-ID tag readers 158 may sense mobile terminal 100's RF-ID tag 110. Alternatively, mobile terminal 100's RF-ID reader 112 may sense one of service provider 150's RF-ID tags 159. In either case, a short range wireless connection between terminal 100 and service provider 150 is established and a shopping mini-application is downloaded from service provider 150 to mobile terminal 100 via network 120. Alternatively, the shopping mini-application may be downloaded from the service provider 150's RF-ID tag 159. Once downloaded, the user may activate the shopping mini-application to assist her in her shopping, as will be discussed in detail hereinafter.

In an alternate embodiment, mobile terminal 100 may have pre-stored the shopping mini-application in advance of entering the service provider 150's shop. For example, the user may have downloaded the shopping mini-application over mobile WAN 130 while in her car driving to the shop and, upon entering the shop, may then activate the mini-application for assistance. Alternatively, activation may be automatic upon coming in close proximity to the shop.

A data file containing information relating to specific items for sale in the shop is also downloaded from service provider 150. Rather than downloading the entire data file from service provider 150, the terminal 100 may access portions of the data file via, e.g., a bi-directional network such as short range wireless network 120 to perform such functions as checking item availability and locations within the shop, and providing recommended substitutes, complimentary items, reminders and special offers to the user, as will be discussed in detail hereinafter.

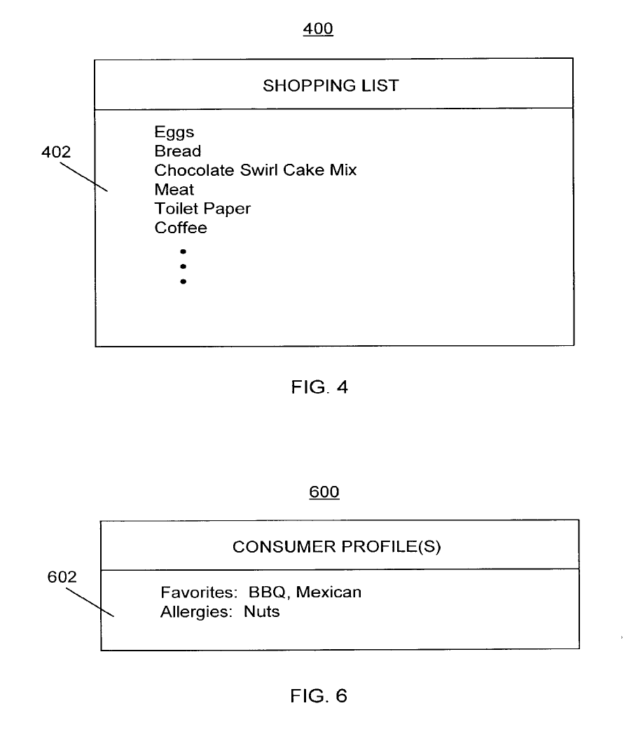

An exemplary data file 500 is illustrated in FIG. 5. As shown in FIG. 5, data file 500 includes records 520 for each item offered for sale in service provider 150's shop. For ease of illustration, however, only a handful of items normally available from service provider 150 are shown in FIG. 5. Each record includes fields for an item description 502, the item's availability 504, the physical location 506 of the item within the shop, complimentary items 508, substitute items 510 and special offers 512.

As will be discussed in detail hereinafter, in addition to the shopping mini-application and data file 500, map data relating to the service provider's shop is also downloaded to mobile terminal 100 for use in generating a map to guide the user through the shop to gather and purchase items on shopping list 400.

Returning to FIG. 3, in step 308, the shopping mini-application identifies items on shopping list 400 that are also listed in field 502 of data file 500 and, for those items identified, determines their availability from field 504 of the associated data record. If any items are unavailable (either because they are currently out of stock or because service provider 150 does not carry them), then in step 310, the mini-application advises the user of their unavailability by, e.g., listing them on display 102 of mobile terminal 100. In step 311, the shopping mini-application determines whether the user has modified the shopping list 400, e.g., to delete an unavailable item and add a substitute item. If the shopping mini-application receives such a modification, the shopping list 400 is updated and then steps 308-311 are repeated until it is concluded that all items on the shopping list 400 are available or no further modifications to shopping list 400 are received (i.e., the user has left on shopping list 400 items that have been identified as not available).

If either all items on the shopping list are available (step 308) or no modifications to shopping list 400 are received after a predetermined period of time has elapsed (step 311) then, in step 312, the shopping mini-application prompts the user whether she would like to receive recommendations of available substitute and/or complimentary items. The user may simply respond “Yes” or “No”. However, more detailed responses may also be available to the user such as “only during this particular visit”, “for all shopping list items”, “only for shopping list items that are unavailable”, “only for shopping list items that are available”, “only for specific individual shopping list items”, etc. Alternatively, the shopping mini-application may determine the user's willingness to receiving such recommendations from a user profile, as will be discussed in detail hereinafter.

A substitute item is one that is similar to, and therefore, can be substituted for, items on shopping list 400. A substitute item may be recommended for an item on the shopping list 400 that is out of stock or otherwise unavailable. For example, as shown in FIG. 4, shopping list 400 includes “chocolate swirl cake mix”. However, as shown in FIG. 5, field 504 of record 522 indicates that this item is currently unavailable. Field 510 of that same record nevertheless provides two possible substitutes—namely, “marble cake mix” and “brownie mix with walnuts”. Both of these substitutes may be presented to the user on display 102 for user consideration and possible selection. Moreover, even if an item on shopping list 400 is available, a substitute item may be recommended, particularly in conjunction with a special offer (e.g., Brand Y coffee, which is not on shopping list 400 but is on sale, may be recommended as a substitute for Brand X coffee, which is on shopping list 400, even though available).

User acceptance of a substitute item may be automatic (e.g., “always”, as may be indicated in her user profile) or require manual acceptance (e.g., either on a per-visit basis for all items on her shopping list or on a per-item basis). If the user accepts a suggested substitute, shopping list 400 is updated to delete the item for which a recommendation was made and add the substitute item to the list.

In one embodiment, the shopping mini-application may access one or more user profiles to better target a substitute to the user. These profiles are preferably created by the user of mobile terminal 100. An exemplary user profile 600 is illustrated in FIG. 6. A user profile 600 may include information 602 such as the user's favorite foods, allergies, etc. For example, in profile 600, the user is indicated as having an allergy to nuts. Therefore, when deciding which of the two substitutes for marble swirl cake mix in field 510 of record 522 to suggest to the user, the shopping mini-application will exclude the “brownie mix with walnuts”.

A user profile 600 may also indicate the user's preferences for usage of the shopping mini-application. More particularly, it may specify whether or not the user wishes to be provided with information discussed herein such as recommendations for substitute and/or complimentary items, reminders, special offers, optimal routes, etc. and, if such information is to be provided, how acceptance by the user is to be indicated (e.g., either automatically or manually, as discussed above).

The user profiles used by the shopping mini-application also may be created by the user of mobile terminal 100 for use in a particular context. For example, the user may have a weekend shopping profile, which, given that the user has more free time on the weekends, allows for a greater number of, or more expensive, recommended items to be considered than a weekday shopping profile. The profile information also may include other information pertaining to the user's shopping context including, but not limited to, whether the user drove to the shop or walked to the shop. In the event that the user drove to the shop, items that require a larger transport capability can be included among those presented to the user.

Alternatively, a user profile may be created by a service provider 150 based on the user's shopping behavior in the past, such as the user's purchasing history 700 illustrated in FIG. 7, which will be discussed in detail below in connection with shopping “reminders” that the mini-application provides to the user in one embodiment of the present invention.

In addition to providing substitute items, the shopping mini-application may provide complimentary items from field 508 for any of the items on the user's shopping list 400 (including any substitutes added to the list 400). A complimentary item is one that compliments an item on shopping list 400. For example, for the item “bread” on shopping list 400, the shopping mini-application may suggest “butter” or “jam”, provided that field 504 of the corresponding records for these suggested complimentary items in data file 500 indicate that they are available. As with suggested substitute items, suggested complimentary items also may be presented to the user for possible selection, and thus, addition to shopping list 400.

If, in step 312, the user chose not to receive recommendations for substitute and/or complimentary items or, in step 316, the shopping mini-application received the user's selection of one or more of the suggested substitute and/or complimentary items and updated the shopping list 400 accordingly then, in step 318, the shopping mini-application prompts the user to determine whether she is to be provided with “reminders”. Reminders may be messages to buy items that do not appear on shopping list 400, but which the user may need based on her purchasing history. Reminders may also be messages not to buy one or more items on the shopping list 400 because the user's purchasing history indicates that she does not presently need them.

An exemplary purchasing history 700 is illustrated in FIG. 7. As shown in FIG. 7, purchasing history 700 includes a listing of one or more items 702 that the user of mobile terminal 100 has purchased in the past. Purchasing history 700 also includes: a timeline 704 representing a period of time (e.g., 1 month) during which the user's purchases have been tracked; indicators 706 along timeline 704 representing periodic units of time (e.g., a day); an indicator of the current time 708 relative to the time line 704; and for each of the items 702, indicator(s) 710 of when the item was purchased.

As can be seen from FIG. 7, purchasing history 700 permits the shopping mini-application to discern for each item, not only the date of the last purchase, but also the frequency of purchases. It will be appreciated that purchasing history 700 may include, for each item purchased, information in addition to a generic name and dates of purchase, such as a brand name, a quality indicator, the quantity and price. Moreover, the data in purchasing history 700 may represent purchases regardless of where made, and thus, may include items that were purchased at different shops or malls than the one in which the user is presently shopping with the assistance of the present invention.

Returning to FIG. 3, if reminders are to be provided, then in step 320, the shopping mini-application compares shopping list 400 with the user's purchasing history and provides reminders to the user of mobile terminal 100. For example, based on shopping list 400 and purchasing history 700 shown in FIGS. 4 and 7, respectively, such recommendations may include that the user: buy milk even though it is not on shopping list 400 because it is purchased every two days and it has been two days since the last purchase; not buy coffee even though it is on the list 400 because it is purchased infrequently and was recently purchased (e.g., 2 days ago); and/or buy chili pepper because the last time meat was purchased chili pepper was also purchased. In the given example, a reminder typically would not be provided for bread, even though purchasing history 700 indicates that it is purchased nearly every day, because it already appears on shopping list 400.

Once the user has been given the reminders, in step 322, the mini-application receives the user's selections (if any) of the items for which reminders have been provided and either adds items to, or deletes items from, shopping list 400. Thereafter, the mini-application updates list 400 accordingly. In one embodiment, the shopping mini-application also may provide suggested substitute or complimentary items for any items sought to be added to the list 400 in response to a reminder.

In step 324, whether or not reminders are provided, the shopping mini-application determines whether there are any special offers and/or rewards associated with any of the items on shopping list 400 by comparing each item on the list 400 with field 512 of the corresponding record in the data file 500. For example, as shown in FIG. 5, an exemplary special offer may be 50 cents off of Marble Cake Mix or $2.00 off of a $20.00 purchase in the Fish Department. In step 326, the user is prompted as to whether she would like to receive special offers and upon her acceptance such special offers are presented to her. In an alternate embodiment, the special offers and/or rewards may be limited only to items for which a recommendation (i.e., substitute/complimentary items) has been made or a reminder has been given. In this alternate embodiment, the special offers and/or rewards are preferably presented to the user at the time that the user is advised of the recommendations or reminders (e.g., steps 316 and 320, respectively) to encourage the user to select and ultimately purchase an item not originally included on shopping list 400.

In step 328, whether or not special offers are provided, the shopping mini-application determines whether the user requested (e.g., in response to a prompt) an optimal route through service provider 150's shop for purchasing items on shopping list 400. If not, then in step 330, the user simply may begin shopping using shopping list 400. If, however, an optimal route is to be provided then, in step 332, shopping mini-application determines the user's current location within the service provider 150's shop using a location defining system, such as the above-discussed RF-ID tag/reader system.

In one embodiment of the present invention, the service provider 150 has one or more RF-ID tags 159 situated throughout its premises, each tag including an ID number that the service provider 150 has associated with a location in its premises and has downloaded to mobile terminal 100, preferably with the shopping mini-application. For example, a service provider 150 may install an RF-ID tag at the entrance of a shop and at certain points throughout the shop. As shown in FIG. 1, the mobile terminal 100 is equipped with an RF-ID tag reader 112, which transmits interrogation signals that are received by one of the foregoing tags 159 as the user passes through the service provider 150's shop. The tag 159 will respond to the interrogation by transmitting a signal that includes its identifier (ID) number to reader 112. Mobile terminal 100 may then compare the received ID number against the list of downloaded ID numbers to determine its present location within the service provider 150's shop.

In an alternate embodiment, the service provider 150 has RF-ID tag readers 158, rather than tags, situated throughout its premises, each reader 158 being associated with a location. The mobile terminal 100 includes an RF-ID tag 110, which, when brought into interrogation range of one of the RF-ID readers 158, transmits information associated with the tag 110, such as a customer identifier, to the reader 158. The service provider's reader 158 then may transmit this information to a central controller (e.g., a server) of service provider 150 over either a wired or wireless connection, which, in turn, can determine the location of the user based on the reader 158 from which the tag information was received. Service provider 150 then may provide mobile terminal 100 and, more particularly, the shopping mini-application with the user's location information via the short-range wireless network 120.

Alternatively, a GPS system may be used to determine the user's geographical coordinates within the premises as is well known in the art.

Once the user's location within the shop has been determined then, in step 334, the shopping mini-application determines the locations of each of the items on shopping list 400 (excluding, of course, any unavailable items still on the list 400). This is accomplished by accessing data file 500 and, more particularly, the location information in field 506 for each item.

Thereafter, in step 336, the shopping mini-application computes the optimal route (e.g., the shortest route) for purchasing the items on shopping list 400. The optimal route is computed based on map data associated with the floor layout of the shop (e.g., external boundaries, entrances, points of sale (“POS”), displays, etc.), which, defines available paths of travel, together with the user's present location and the locations of items on shopping list 400. The map data may be downloaded at the time that the mini-application is downloaded or, alternatively, may be downloaded only after it is determined that an optimal route is to be computed. The computation of optimal travel routes and the display of same are well-known, as illustrated by U.S. Pat. No. 5,559,707 to DeLorme et al. (“DeLorme”), issued Sep. 24, 1996 and entitled “Computer Aided Routing System”, a copy of which is incorporated herein by reference. DeLorme discloses a system for determining an optimal travel route between a user-selected travel origin and travel destination following user-selected points along the way and displaying the optimal route to the user on a computer display.

In one embodiment of the present invention, once an optimal shopping route through service provider 150's shop is computed, it is displayed to the user on display 102 of mobile terminal 100 together with the user's present location and the locations of items on shopping list 400 as overlays to the floor plan.

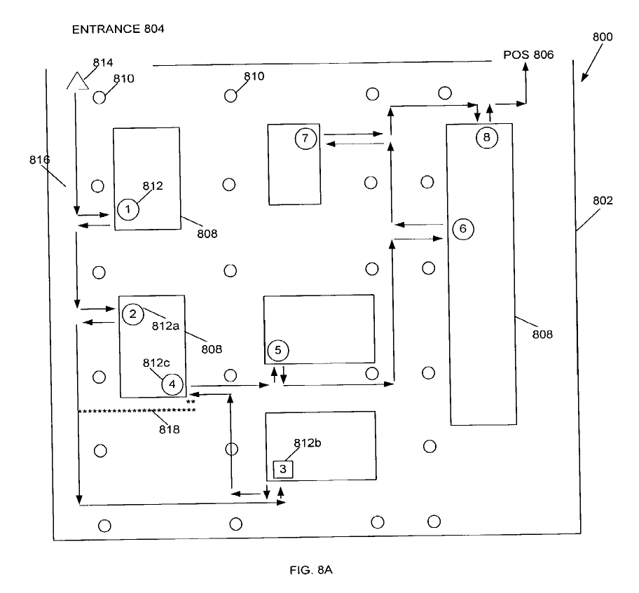

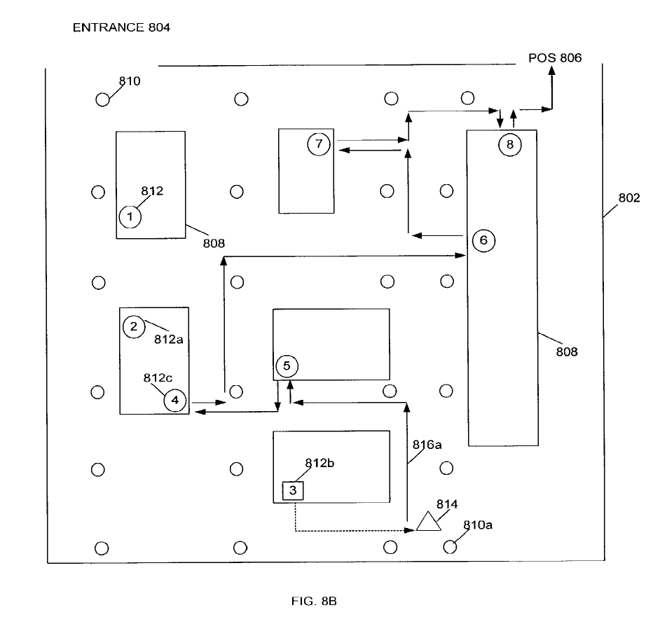

FIG. 8A is a block diagram illustrating an optimal shopping route displayed to a consumer in accordance with one embodiment of the present invention. As shown therein, the map includes the floor plan 800 of the shop including external boundaries 802, an entrance 804, a POS 806 and displays 808. Also shown in FIG. 8A are location beacons 810 (e.g., RF-ID tag readers 158 or RF-ID tags 159 used to determine the user's location). It will be appreciated that the number of beacons used and their locations given the shop's floor plan 800 will determine the precision of the location defining function. Overlayed onto the floor plan 800 are the locations 812 of the items on shopping list 400, the user's present location 814 and the optimal shopping route 816. The user's location may be made highly visible through the use of animation and/or a contrasting color, provided of course that display 102 is capable of such features. Moreover, the optimal shopping route 812 may be supplemented with signs or other visuals that the user will encounter along the route, thereby providing additional information to assist the user in correlating the route displayed on mobile terminal 100 with the route traveled.

As also shown in FIG. 8A, location 812b corresponds to an item suggested by the shopping mini-application (as either a complimentary item, a substitute item or a reminder) that the user selected and added to shopping list 400. The path 818 illustrates how the optimal route 816 would have been computed and displayed by the shopping mini-application to guide the user from location 812a to location 812c had the user not added the suggested item found at location 812b to shopping list 400.

Returning to FIG. 3, after the optimal route has been computed and displayed, the user, in step 338, begins shopping. As the user shops, she may check off or remove the items in shopping list 400 that she has picked up. The user may identify each item added to her shopping cart by using a scanner (not shown) or RF-ID tag reader 112 of mobile terminal 100. Likewise, she may strike items in list 400 that she has decided not to purchase.

In step 340, the shopping mini-application determines whether the user has reached the POS 806, in one embodiment, by monitoring for receipt of an ID number of an RF-ID tag 159 assigned to the POS 806. If the POS 806 has been reached, the shopping mini-application may be deactivated or, preferably, may be deleted altogether from mobile terminal 100 so that the memory occupied by the mini-application and accompanying data can be used for other purposes. Prior to deactivating or deleting the mini-application, user data 108a, such as the purchasing history 700, preferably is updated to reflect the user's purchases during the current shopping trip.

If the POS 340 has not been reached then, in step 344, the shopping mini-application monitors for any modifications made by the user to the shopping list 400. Such modifications may include the addition of new items to the list 400. Preferably, the shopping mini-application will also determine whether any items sought to be newly added by the user are unavailable and advise her of any complimentary or substitute items or reminders for the added items. Modifications may also include the deletion of items from the list 400 because either the user has decided not to purchase them or has added them to her shopping cart. If a modification is received from the user then, in step 346, the shopping mini-application will modify list 400 accordingly.

Regardless of whether or not the shopping list 400 has been modified, in step 348, the shopping mini-application determines whether the optimal route should be updated. The mini-application may automatically update the route periodically or even continuously as the user shops. Alternatively, an update may occur only in response to one or more triggers that the shopping mini-application senses. For example, one trigger may be an explicit request from the user for an update. A user may request an update at any point while in the shop. Another trigger may be the addition of an item to, or deletion of an item from, shopping list 400 by the user. Yet another trigger may be that the user has strayed more than a predetermined distance from the optimal route that was originally displayed to her and needs assistance getting back on track.

FIG. 8B is a block diagram illustrating an exemplary updated optimal shopping route in accordance with one embodiment of the present invention. As shown in FIG. 8B, after purchasing an item at location 812b, rather than following the original optimal route to purchase the next item at location 812c as shown in FIG. 8A, the user strayed from that route. In accordance with the present invention, the user has requested an updated route based on both her present location as determined from location beacon 810a and items remaining on the shopping list that have yet to be gathered. The updated route is illustrated in FIG. 8B by reference numeral 816a.

Returning to FIG. 3, if it is determined in step 348 that the optimal route should not be updated, then steps 338-348 are repeated until either an update should be performed or the user has reached the POS 806. If, however, it is determined that the optimal route should be updated, steps 332-348 are repeated (i.e., determining the user's location and items on shopping list, calculating an optimal route, displaying the optimal route to user, monitoring for subsequent events, etc.), once again, until either another update is needed or the POS 806 is reached.

The many features and advantages of the present invention are apparent from the detailed specification, and thus, it is intended by the appended claims to cover all such features and advantages of the invention which fall within the true spirit and scope of the invention. For example, one or more computational functions, such as the calculation of an optimal route, which is performed in one embodiment by mobile terminal 100 may instead be performed by service provider 150 and the results transmitted to mobile terminal 100 via short range wireless network 120 for display to the user. Moreover, in an alternate embodiment, recommended substitutes/complimentary items, reminders, directions, etc., may be delivered to the user audibly rather than visually.

Furthermore, since numerous modifications and variations will readily occur to those skilled in the art, it is not desired that the present invention be limited to the exact construction and operation illustrated and described herein, and accordingly, all suitable modifications and equivalents which may be resorted to are intended to fall within the scope of the claims.

1. A method for providing a user of a mobile terminal with shopping advice, comprising:
accessing a user's electronic shopping list;
identifying a substitute item for an item on the shopping list;
notifying the user of the substitute item via the mobile terminal; and
providing the user with a route for purchasing items on the shopping list,
wherein the route includes a location of the substitute item.

2. The method of claim 1 wherein the mobile terminal is a mobile telephone.

3. The method of claim 1 wherein a substitute item is identified for an item on the shopping list that is unavailable.

4. The method of claim 1 wherein a substitute item is identified for an item on the shopping list that is available.

5. The method of claim 1 further comprising:
accessing a profile of the user,
wherein identifying a substitute item includes identifying an item in accordance with the user's profile.

6. The method of claim 1 further comprising:
receiving the user's selection of the substitute item.

7. The method of claim 1 further comprising:
downloading shopping application software to the mobile terminal to enable shopping advice to be provided to the user.

8. The method of claim 7 wherein the application software is downloaded via a short range wireless connection upon entering a predetermined location.

9. The method of claim 7 wherein the application software is downloaded via a mobile wide area network.

10. The method of claim 7 wherein the application software is specific to a service provider's premises.

11. The method of claim 1 further comprising:
transmitting a request to a service provider to determine availability of items on the shopping list.

12. The method of claim 1 further comprising:
modifying the shopping list to include the substitute item.

13. The method of claim 1 further comprising:
notifying the user via the mobile terminal of special offers associated with a substitute item.

14. The method of claim 1 further comprising:
determining the user's location;
determining a location of items on the shopping list, including the location of the substitute item; and
computing a route for purchasing items on the shopping list, including purchasing the substitute item.

15. The method of claim 14 wherein the user's location is determined via an RF-ID system.

16. The method of claim 15, wherein the RF-ID system comprises a service provider including one or more RF-ID tags and the mobile terminal includes an RF-ID reader that is capable of reading the one or more RF-ID tags, the method further comprising:
associating each tag with a location;
receiving a tag identifier at the reader of the mobile terminal; and
determining a location of the mobile terminal based on the tag identifier.

17. The method of claim 15, wherein the RF-ID system comprises the mobile terminal, which includes an RF-ID tag that is capable of being read by one or more RF-ID readers associated with a service provider, the method further comprising:
receiving, at the tag, an interrogation from a reader;
transmitting a tag identifier to the reader to enable the service provider to determine a location of the mobile terminal; and
receiving location information from the service provider.

18. The method of claim 14, further comprising:
updating the route in response to a user request.

19. The method of claim 14, further comprising:
updating the route in response to modifications to the shopping list.

20. The method of claim 14, further comprising:
updating the route in response to the user's divergence from the route.

21-42. (canceled)
